(19) United States
(12) Patent Application Publication
(10) Pub. No.: US 2005/0055374 A1
(43) Pub. Date: Mar. 10, 2005

(54) Method of and apparatus for providing localized information from an internet server or portal to user without requiring user to enter location

(75) Inventor: Naoyuki Sato, Campbell, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics, Inc.

(21) Appl. No.: 10/658,057

(22) Filed: Sep. 8, 2003

(51) Int. Cl. G06F 7/00

(52) U.S. Cl. 707/104.1

(57) ABSTRACT

The method of and apparatus for providing localized information from an internet server or portal to a user without requiring the user to enter their location information preferably maintains a location table of the IP addresses for wireless access points and the location information for the access point. When a user accesses a portal through a wireless access point to obtain localized information, the portal then determines, using the IP address for the wireless access point and the location table, the location information corresponding to that wireless access point. The portal then provides the localized information to the user for their location based on the location information obtained from the location table without requiring the user to know or enter the location information. In an alternative embodiment, the location information is maintained at the wireless access point and automatically provided to the portal from the wireless access point.

### FIELD OF THE INVENTION

The present invention relates to the field of determining a location of a user and providing information to the user. More particularly, the present invention relates to the field of determining a location of a user and providing information to the user pertaining to their location.

### BACKGROUND OF THE INVENTION

Traditionally users have accessed the internet from computers in fixed locations, such as the home or office. With recent advances in computer hardware and wireless communications, an increasing number of users are using the internet from small, wireless, devices such as laptops, personal digital assistants (PDAs) and cell phones from almost any location. There are many standards and technologies available for accessing the internet from various locations. One technology for wirelessly accessing the internet is specified by the IEEE 802.11b communications standard, which is otherwise known as Wi-Fi. This communications standard is the wireless equivalent of the Ethernet protocol, specified by the IEEE 802.3 communications standard.

The IEEE 802.11b communications standard defines the physical layer and media access control (MAC) sublayer for communications across a shared, wireless local area network (WLAN). At the physical layer, IEEE 802.11b operates at the radio frequency of 2.45 gigahertz with a maximum bit rate of 11 Mbps. Wi-Fi uses the direct sequence spread spectrum (DSSS) transmission technique. At the MAC sublayer of the data link layer, Wi-Fi uses the carrier sense multiple access with collision avoidance (CSMA/CA) media access control (MAC) protocol.

A wireless station with a frame to transmit first listens on the wireless medium to determine if another station is currently transmitting. If the medium is being used, the wireless station calculates a random backoff delay. Only after the random backoff delay elapses can the wireless station again listen for a transmitting station. By instituting a random backoff delay, multiple stations that are waiting to transmit do not end up trying to transmit at the same time.

Within a Wi-Fi network, a station is a network node that is equipped with a wireless network device. A personal computer with a wireless network adapter is known as a wireless client. Wireless clients can communicate directly with each other or through a wireless access point. Wireless clients are mobile.

A wireless access point is a wireless network node that acts as a bridge between stations and a network. A wireless access point contains at least one interface that connects the wireless access point to an existing network, such as an ethernet backbone, a wireless network device with which it generates wireless connections with stations and bridging software, so that the wireless access point can act as a transparent bridge between the wireless and existing networks. A wireless access point is similar to a cellular phone network's base station. Wireless clients communicate with both the existing network and other wireless clients through the wireless access point. Wireless access points act as peripheral bridge devices that extend a network.

Within a wireless network, a port is a channel of a device that can support a single point-to-point connection. A port is an association, which provides a logical entity over which a single wireless connection is made. A typical wireless client with a single wireless network adapter has one port and can support only one wireless connection. A typical wireless access point has multiple ports and can simultaneously support multiple wireless connections. The logical connection between a port on the wireless client and the port on a wireless access point is a point-to-point bridged local area network segment, similar to an ethernet-based network client that is connected to an ethernet switch.

A single wireless access point that supports one or more multiple wireless clients is known as a basic service set. A set of two or more wireless access points that are connected to the same network is known as an extended service set. An extended service set is a single logical network segment, also known as a subnet, and is identified by its service set identifier. If the available physical areas of the wireless access points in an extended service set overlap, then a wireless client can roam, or move from one location, with a wireless access point, to another, with a different wireless access point, while maintaining network layer connectivity.

When a wireless adapter is turned on, it begins to scan across the wireless frequencies for wireless access points and other wireless clients in the ad hoc mode. Assuming that the wireless client is configured to operate in the infrastructure mode, the wireless adapter chooses a wireless access point with which to connect. This selection is made automatically by using a service set identifier and signal strength and frame error rate information. Next, the wireless adapter switches to the assigned channel of the selected wireless access point and negotiates the use of a port. This is known as establishing an association.

If the signal strength of the wireless access point with which an association is established, is too low, the error rate is too high, or if instructed by the operating system, the wireless adapter scans for other wireless access points to determine whether a different wireless access point can provide a stronger signal or lower error rate. If such a wireless access point is located, the wireless adapter switches to the channel of that wireless access point and negotiates the use of a port. This is known as reassociation with a different wireless access point and can occur for several reasons. The signal can weaken as either the wireless adapter moves away from the wireless access point or the wireless access point becomes congested with too much traffic or interference. By switching to another wireless access point, the wireless adapter can distribute the load to other wireless access points, increasing the performance for other wireless clients. Contiguous coverage over large areas can be achieved by placing wireless access points so that their signal areas slightly overlap. As a wireless client roams across different signal areas, it can associate and reassociate from one wireless access point to another wireless access point, maintaining a continuous logical connection to the network.

To use Wi-Fi, a user is required to have a Wi-Fi transceiver installed in an access device, such as a laptop or PDA. Wi-Fi access is provided by base stations or access points. An individual access point can service many Wi-Fi users and usually has a range or approximately 300 feet, although this number is growing as the technology improves. In fact, some access point devices have a range of several miles.

Typically users accessing wireless access points from a wireless client such as a laptop or a PDA are traveling or away from their home or local area. Accordingly, in many instances, the user is not familiar with specific information regarding the user's current location, such as the postal zip code, county and sometimes even the particular city that the user is in. Such users are generally at hotels, airports or on business trips or in unfamiliar locations. For such users, accessing a portal to obtain localized information such as news, weather, traffic information and nearby locations of interest, is oftentimes difficult, because such portals require the entry of a postal zip code or city name. If a user is not sure of the postal zip code or city name, then they are not able to gain access to the localized information. In other instances, when the user knows where they are but they are in a hurry, entering the location information such as the postal zip code or city name, can be a time consuming step in the process of obtaining localized information from such a portal.

### SUMMARY OF THE INVENTION

The method of and apparatus for providing localized information from an internet server or portal to a user without requiring the user to enter their location information of the present invention preferably maintains a location table of the IP addresses for wireless access points and the location information for the access point. When a user accesses a portal through a wireless access point to obtain localized information, the portal then determines, using the IP address for the wireless access point and the location table, the location information corresponding to that wireless access point. The portal then provides the localized information to the user for their location based on the location information obtained from the location table without requiring the user to know or enter the location information. In an alternative embodiment, the location information is maintained at the wireless access point and automatically provided to the portal from the wireless access point.

In one aspect of the present invention, a method of providing localized information to a user accessing an internet site through an access point, comprises determining an address corresponding to the access point, obtaining location information corresponding to the address from a location table, obtaining localized information using the location information and providing the localized information to the user through the access point. The address is an internet protocol address. The method further comprises generating an entry in the location table including the address and corresponding location information. The method further comprisese obtaining the corresponding location information from the access point. The localized information preferably includes one or more of weather, news, traffic information and information regarding nearby points of interest. In one embodiment, the internet site is provided by an internet server. In another embodiment, the internet site is provided by an internet portal. The localized information is obtained from a localized information database.

In another aspect of the present invention, a method of generating a location table corresponding to locations of access points, comprises obtaining an address of the access point from a communication received from the access point, obtaining location information corresponding to a physical location of the access point, generating an entry within the location table including the address and the location information and repeating obtaining an address, obtaining location information and generating an entry for a first communication from each access point. The address is an internet protocol address. The communication is received at an internet site. In one embodiment, the internet site is provided by an internet server. In another embodiment, the internet site is provided by an internet portal.

In a further aspect of the present invention, an apparatus to provide an internet site and capable of being accessed through an access point comprises a location table including a plurality of entries each having an address and location information corresponding to an access point and a localized information database coupled to the location table to provide localized information based on the location information. The address is an internet protocol address. The apparatus further comprises a controller coupled to the location table and the localized information database for generating an entry in the location table including the address and corresponding location information. The controller obtains the location information from the access point. The localized information includes one or more of weather, news, traffic information and information regarding nearby points of interest. In one embodiment, the apparatus is within an internet server. In another embodiment, the apparatus is within an internet portal.

In still a further aspect of the present invention, an apparatus for providing an internet site and capable of being accessed through an access point comprises a first means for maintaining a plurality of entries each having an address and location information corresponding to an access point and a second means for maintaining a localized information database coupled to the first means for maintaining for providing localized information based on the location information. The address is an internet protocol address. The apparatus further comprises a means for controlling coupled to the first means for maintaining and to the second means for maintaining for generating an entry in the first means for maintaining including the address and corresponding location information. The means for controlling obtains the location information from the access point. The localized information includes one or more of weather, news, traffic information and information regarding nearby points of interest. In one embodiment, the apparatus is within an internet server. In another embodiment, the apparatus is within an internet portal.

In another aspect of the present invention, a location table maintained by an internet site for providing localized information to users through an access point comprising a plurality of entries, each entry including an address corresponding to the access point and location information corresponding to the access point. The address is an internet protocol address. In one embodiment, the internet site is provided by an internet server. In another embodiment, the internet site is provided by an internet portal. The location information is a physical location of the access point.

In a further aspect of the present invention, a network of devices comprises one or more access points to provide access to an internet site, one or more internet access systems, each capable of communicating with the one or more access points to access the internet site through the access point, an apparatus to provide the internet site and capable of being accessed through the one or more access points comprising a location table including a plurality of entries each having an address and location information corresponding to an appropriate one of the access points and a localized information database coupled to the location table to provide localized information based on the location information. The access points are wireless access points. The one or more internet access systems are one or more of a portable computer, a cellular telephone and a personal digital assistant device. The address is an internet protocol address. The apparatus to provide the internet site further comprises a controller coupled to the location table and the localized information database for generating an entry in the location table including the address and corresponding location information after receiving a first communication from an access point. The controller obtains the location information from the access point. The localized information includes one or more of weather, news, traffic information and information regarding nearby points of interest. In one embodiment, the apparatus to provide the internet site is within an internet server. In another embodiment, the apparatus to provide the internet site is within an internet portal.

### BRIEF DESCRIPTION OF THE DRAWINGS

FIG. 1 illustrates a block diagram of an exemplary wireless network according to the preferred embodiment of the present invention.

FIG. 2 illustrates a block diagram of the internal components of a computer system used by a user to access the internet server/portal 10 of the present invention.

FIG. 3 illustrates an exemplary location table of the present invention.

FIG. 4 illustrates an exemplary configuration of users and access points.

FIG. 5 illustrates a flowchart showing the process followed by the internet server/portal 10 of the preferred embodiment of the present invention.

FIG. 6 illustrates a block diagram of the relevant internal components within the internet server/portal 10 of the preferred embodiment.

### DETAILED DESCRIPTION OF THE PREFERRED EMBODIMENT

The method of and apparatus for providing localized information from an internet server or portal to a user without requiring the user to enter their location information of the present invention preferably maintains a location table of the IP addresses for wireless access points and the location information for the access point. The location table is preferably maintained at an internet server/portal and generated as wireless access points first establish communications with the internet server/portal. When a wireless access point connects to an internet server/portal, the internet server/portal first compares the IP address of the wireless access point to the location table to determine if the internet server/portal already has the location information for the wireless access point. If the IP address of the wireless access point is not in the location table, then the internet server/portal obtains the location information from the wireless access point. This location information is preferably entered by an administrator responsible for the installation and maintenance of the wireless access point, and resident within the wireless access point. Alternatively, the internet server/portal obtains the location information from the first user who accesses the internet server/portal through the wireless access point. Once obtained, this location information is then maintained within the location table corresponding to the IP address of the wireless access point.

When a user accesses an internet server/portal through a wireless access point to obtain localized information, the internet server/portal then determines, using the IP address for the wireless access point and the location table, the location information corresponding to that wireless access point. The internet server/portal then provides the localized information to the user for their location based on the location information obtained from the location table without requiring the user to know or enter the location information. This localized information can include any information relating to the location such as the weather, news, traffic and/or nearby locations of interest. In an alternative embodiment, the location information is maintained at the wireless access point and automatically provided to the internet server/portal from the wireless access point each time that is needed to provide a user information.

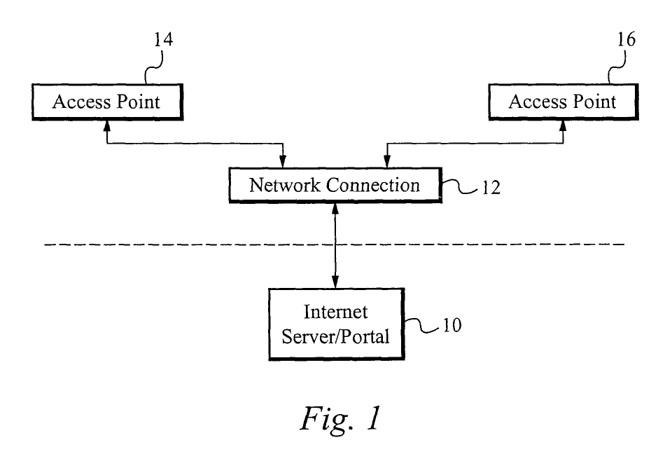

A block diagram of an exemplary wireless network according to the preferred embodiment of the present invention is illustrated in FIG. 1. An internet server/portal 10 is coupled to an internet network connection 12 to allow communications between both the internet server/portal 10 and the access points 14 and 16. This internet network connection can be any appropriate connection which connects the internet server 10 to the internet, including a wired connection such as through the public switched telephone network, cable or other appropriate wired or wireless connection, including a satellite link. Users within the vicinity of either of the access points 14 and 16 gain access to the internet through the access points 14 and 16. Each of the access points 14 and 16 are coupled to the internet network connection 12 to allow the users to access the internet and the internet server/portal 10.

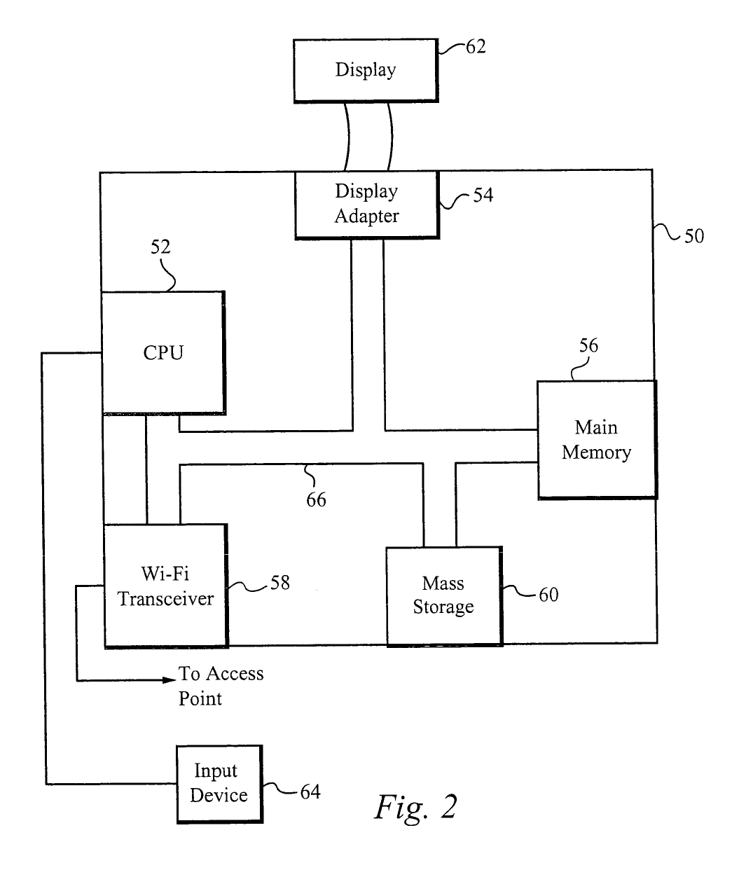

A block diagram of the internal components of a computer system used by a user to access the internet server/portal 10 of the present invention is illustrated in FIG. 2. While the internet server 10 can be accessed from any appropriately configured computer system or wireless internet access device, an exemplary computer system 50 for accessing the internet server/portal 10 is illustrated in FIG. 2. The exemplary computer system 50 includes a CPU 52, a main memory 56, a display adapter 54, a mass storage device 60 and a Wi-Fi transceiver 58, all coupled together by a conventional bidirectional system bus 66. The Wi-Fi transceiver 58 preferably operates according to the IEEE 802.11b standard and wirelessly accesses available wireless access points. The Wi-Fi transceiver 58 can be any appropriate device for sending and receiving communications over a Wi-Fi connection, such as a Wi-Fi card or circuit. The mass storage device 60 may include both fixed and removable media using any one or more of magnetic, optical or magneto-optical storage technology or any other available mass storage technology. The system bus 66 contains an address bus for addressing any portion of the memory 56 and 60. The system bus 66 also includes a data bus for transferring data between and among the CPU 52, the main memory 56, the display adapter 54, the mass storage device 60 and the Wi-Fi transceiver 58.

The computer system 50 is also coupled to a number of peripheral input and output devices including the input device 64 and the associated display 62. The input device 64 may be any appropriate input device including keyboard, mouse, touch screen or stylus.

The display adapter 54 interfaces between the components within the computer system 50 and the display 62. The display adapter 54 converts data received from the components within the computer system 50 into signals which are used by the display 62 to generate images for display.

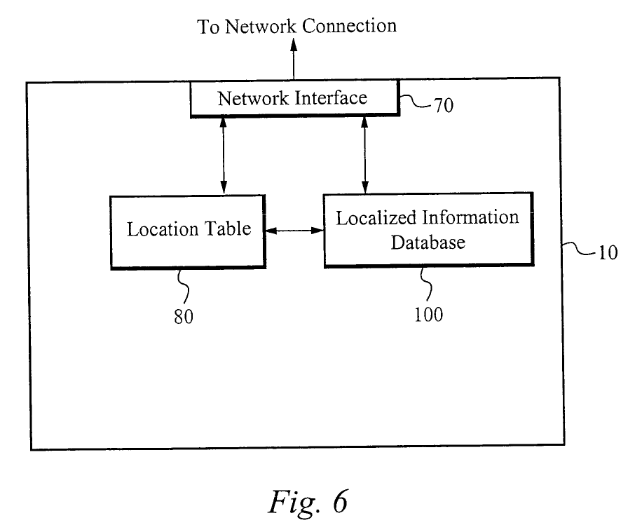

A block diagram of the relevant internal components within the internet server/portal 10 of the preferred embodiment is illustrated in FIG. 6. The internet server/portal 10 includes a network interface 70 coupled to the network connection 12 (FIG. 1) to communicate with the wireless access points 14 and 16 (FIG. 1) over the internet. The internet server/portal 10 also includes a location table 80 and a localized information database 100, which are both coupled to each other and to the network interface 70. The location table 80 stores the IP addresses corresponding to wireless access points and the corresponding location information. The localized information database 100 includes localized information such as weather, news, traffic information and information regarding nearby points of interest, pertaining to specific locations.

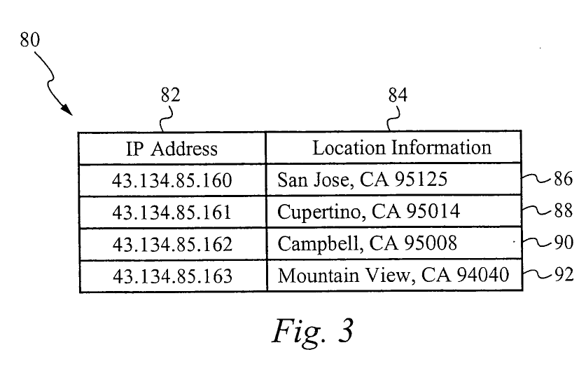

An exemplary location table 80 of the present invention is illustrated in FIG. 3. The location table 80 includes an IP address column 82 and a location information column 84. The IP address column 82 includes the IP address of an access point. The location information column 84 includes the physical or geographical location information corresponding to the location of the access point. The exemplary location table 80 of FIG. 3, includes four entries 86, 88, 90 and 92, corresponding to four different access points. The location table entry 86 corresponds to the access point having an IP address of 43.134.85.160. The physical location of this access point is San Jose, Calif. within the postal zip code of 95125. The location table entry 88 corresponds to the access point having an IP address of 43.134.85.161. The physical location of this access point is Cupertino, Calif. within the postal zip code of 95014. The location table entry 90 corresponds to the access point having an IP address of 43.134.85.162. The physical location of this access point is Campbell, Calif. within the postal zip code of 95008. The location table entry 92 corresponds to the access point having an IP address of 43.134.85.163. The physical location of this access point is Mountain View, Calif. within the postal zip code of 94040.

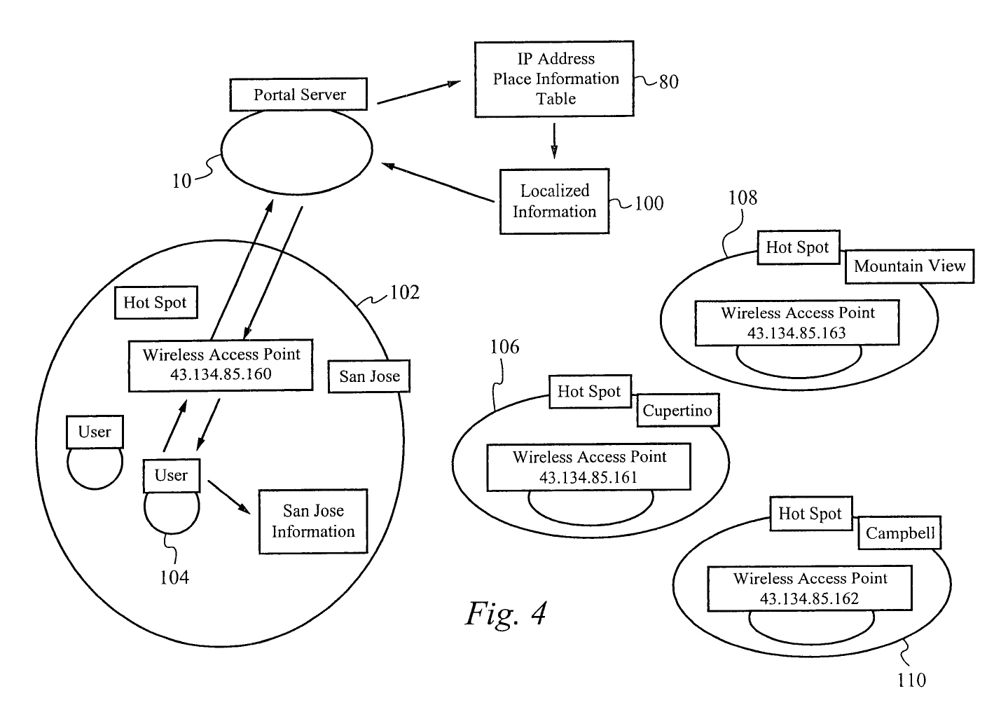

An exemplary configuration of users and access points is illustrated in FIG. 4. Each of the wireless access points 102, 106, 108 and 110 have an associated range, as shown by the circular areas around each access point 102, 106, 108 and 110. The wireless access point 102 corresponds to the location table entry 86, within the location table 80 shown in FIG. 3, and is physically located in San Jose, Calif. The wireless access point 106 corresponds to the location table entry 88 and is physically located in Cupertino, Calif. The wireless access point 110 corresponds to the location table entry 90 and is physically located in Campbell, Calif. The wireless access point 108 corresponds to the location table entry 92 and is physically located in Mountain View, Calif.

As described above, users within the range of any of the wireless access points 102, 106, 108 and 110, gain access to the internet server/portal 10 through the network connection 12. In the exemplary configuration illustrated in FIG. 4, a user 104 within the range of the wireless access point 102, gains access to the internet server/portal 10 through the wireless access point 102. The user 104 accesses the wireless access point 102 and then through this access, accesses the internet server/portal 10. Once connected to the internet server/portal 10, the user 104 has the ability to obtain any information available from or through the internet server/portal 10. When the user 104 requests access to any localized information pertaining to their current location, the internet server/portal 10 looks up the IP address of the wireless access point 102 in the location table 80. The IP address of the wireless access point 102 is contained within the location table entry 86. From the location table entry 86, the internet server/portal 10 then obtains the physical location information of San Jose, Calif. 95125, corresponding to the wireless access point 102. This location information is then used by the internet server/portal 10 to provide specific localized information pertaining to the location of the user 104. Accordingly, when the user 104 requests localized information such as weather, news, traffic and nearby points of interest, the internet server/portal 10 can provide the requested information to the user without requiring the user to enter their physical location information.

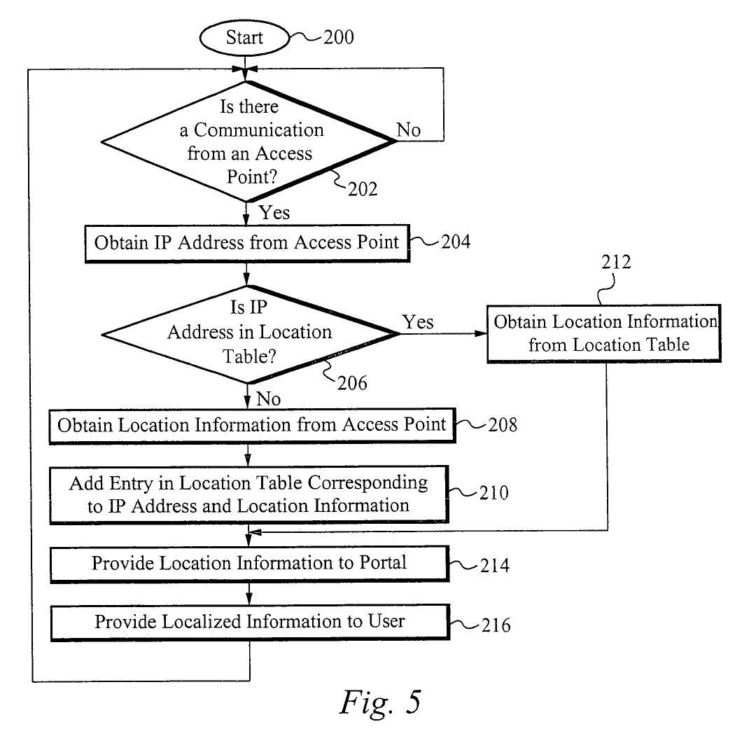

A flowchart illustrating the process followed by the internet server/portal 10 of the preferred embodiment of the present invention is illustrated in FIG. 5. The process of FIG. 5 begins at the step 200. At the step 202, the internet server/portal 10 waits until it has received a communication from an access point. Once the internet server/portal 10 receives a communication from an access point, then, at the step 204, the internet server/portal 10 obtains the IP address from the access point. At the step 206, it is then determined if the IP address obtained at the step 204 is currently included within the location table. If it is determined at the step 206 that the IP address is not included in the location table, then the location information is obtained from the access point 208. Preferably, the location information is maintained or stored within the wireless access point and can be automatically provided to the internet server/portal 10. In this preferred embodiment, an installer enters the physical location information into the wireless access point upon installation of the wireless access point into its location. In this preferred embodiment, the physical location is stored in memory of the wireless access point. In an alternative embodiment, when the location information is not stored at the access point, the internet server/portal prompts the initial user for the location information. Once the location information is obtained, the internet server/portal adds a location entry for the access point into the location table, at the step 210. This location entry includes the IP address and the location information corresponding to the access point.

If it is determined at the step 206 that the IP address is included in the location table, then the location information is obtained from the appropriate entry within the location table, at the step 212. Once the location information is obtained, the location information is provided to the internet server/portal at the step 214. At the step 216, the location information is then used to obtain the localized information from the localized information database and provide the localized information to the user. The internet server/portal then returns to the step 202 to wait to receive another communication from an access point.

In operation, a user accesses a wireless access point to gain access to the internet. If the user desires localized information about the user's current location, the user accesses the internet server/portal 10 of the present invention. From this communication, the internet server/portal 10 obtains the IP address of the wireless access point. Using the IP address, the internet server/portal 10 determines if there is a location entry within the location table 80 corresponding to the IP address. If there is not a location entry corresponding to the IP address, the internet server/portal 10 generates an entry by obtaining the physical location information corresponding to the wireless access point. If there is a location entry corresponding to the IP address, the internet server/portal 10 obtains the location information from this entry. The physical location information is then used to obtain the requested location information for the user from the localized information database 100. The requested location information is then provided to the user over the internet and through the wireless access point.

In this manner, a user is provided localized information without requiring the user to enter or know the location information corresponding to the user's current physical location. This aids users who are unsure of their current location and users who are in a hurry and would like to save time in obtaining localized information. As should be apparent to those skilled in the art, once the location information for a wireless access point is known, the localized information can also be provided automatically from the internet server/portal to all users accessing the internet server/portal through the wireless access point.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention. Specifically, it will be apparent to those skilled in the art that while the preferred embodiment of the present invention is accessible over the internet, the present invention could also be accessible on any other appropriate communication structures, including intranets, direct connections and the like. Further, it will be also be apparent to those skilled in the art that while the embodiment chosen for illustration uses an access point operating according to the IEEE 802.11b communications standard, the present invention is operable with an access point operating according to any appropriate communication standard or combination of communication standards, including any one or more current or future 802.11 standards.

1. A method of providing localized information to a user accessing an internet site through an access point, comprising:
a. determining an address corresponding to the access point;
b. obtaining location information corresponding to the address from a location table;
c. obtaining localized information using the location information; and
d. providing the localized information to the user through the access point.

2. The method as claimed in claim 1 wherein the address is an internet protocol address.

3. The method as claimed in claim 1 further comprising generating an entry in the location table including the address and corresponding location information.

4. The method as claimed in claim 3 further comprising obtaining the corresponding location information from the access point.

5. The method as claimed in claim 1 wherein the localized information includes one or more of weather, news, traffic information and information regarding nearby points of interest.

6. The method as claimed in claim 1 wherein the internet site is provided by an internet server.

7. The method as claimed in claim 1 wherein the internet site is provided by an internet portal.

8. The method as claimed in claim 1 wherein the localized information is obtained from a localized information database.

9. A method of generating a location table corresponding to locations of access points, comprising:
a. obtaining an address of the access point from a communication received from the access point;
b. obtaining location information corresponding to a physical location of the access point;
c. generating an entry within the location table including the address and the location information; and
d. repeating a-c for a first communication from each access point.

10. The method as claimed in claim 9 wherein the address is an internet protocol address.

11. The method as claimed in claim 9 wherein the communication is received at an internet site.

12. The method as claimed in claim 11 wherein the internet site is provided by an internet server.

13. The method as claimed in claim 11 wherein the internet site is provided by an internet portal.

14. An apparatus to provide an internet site and capable of being accessed through an access point comprising:
a. a location table including a plurality of entries each having an address and location information corresponding to an access point; and
b. a localized information database coupled to the location table to provide localized information based on the location information.

15. The apparatus as claimed in claim 14 wherein the address is an internet protocol address.

16. The apparatus as claimed in claim 14 further comprising a controller coupled to the location table and the localized information database for generating an entry in the location table including the address and corresponding location information.

17. The apparatus as claimed in claim 16 wherein the controller obtains the location information from the access point.

18. The apparatus as claimed in claim 14 wherein the localized information includes one or more of weather, news, traffic information and information regarding nearby points of interest.

19. The apparatus as claimed in claim 14 wherein the apparatus is within an internet server.

20. The apparatus as claimed in claim 14 wherein the apparatus is within an internet portal.

21. An apparatus for providing an internet site and capable of being accessed through an access point comprising:
a. a first means for maintaining a plurality of entries each having an address and location information corresponding to an access point; and
b. a second means for maintaining a localized information database coupled to the first means for maintaining for providing localized information based on the location information.

22. The apparatus as claimed in claim 21 wherein the address is an internet protocol address.

23. The apparatus as claimed in claim 21 further comprising a means for controlling coupled to the first means for maintaining and to the second means for maintaining for generating an entry in the first means for maintaining including the address and corresponding location information.

24. The apparatus as claimed in claim 23 wherein the means for controlling obtains the location information from the access point.

25. The apparatus as claimed in claim 21 wherein the localized information includes one or more of weather, news, traffic information and information regarding nearby points of interest.

26. The apparatus as claimed in claim 21 wherein the apparatus is within an internet server.

27. The apparatus as claimed in claim 21 wherein the apparatus is within an internet portal.

28. A location table maintained by an internet site for providing localized information to users through an access point comprising a plurality of entries, each entry including:
a. an address corresponding to the access point; and
b. location information corresponding to the access point.

29. The location table as claimed in claim 28 wherein the address is an internet protocol address.

30. The location table as claimed in claim 28 wherein the internet site is provided by an internet server.

31. The location table as claimed in claim 28 wherein the internet site is provided by an internet portal.

32. The location table as claimed in claim 28 wherein the location information is a physical location of the access point.

33. A network of devices comprising:
a. one or more access points to provide access to an internet site;
b. one or more internet access systems, each capable of communicating with the one or more access points to access the internet site through the access point;
c. an apparatus to provide the internet site and capable of being accessed through the one or more access points comprising:
i. a location table including a plurality of entries each having an address and location information corresponding to an appropriate one of the access points; and
ii. a localized information database coupled to the location table to provide localized information based on the location information.

34. The network of devices as claimed in claim 33 wherein the access points are wireless access points.

35. The network of devices as claimed in claim 33 wherein the one or more internet access systems are one or more of a portable computer, a cellular telephone and a personal digital assistant device.

36. The network of devices as claimed in claim 33 wherein the address is an internet protocol address.

37. The network of devices as claimed in claim 33 wherein the apparatus to provide the internet site further comprises a controller coupled to the location table and the localized information database for generating an entry in the location table including the address and corresponding location information after receiving a first communication from an access point.

38. The network of devices as claimed in claim 37 wherein the controller obtains the location information from the access point.

39. The network of devices as claimed in claim 33 wherein the localized information includes one or more of weather, news, traffic information and information regarding nearby points of interest.

40. The network of devices as claimed in claim 33 wherein the apparatus to provide the internet site is within an internet server.

41. The network of devices as claimed in claim 33 wherein the apparatus to provide the internet site is within an internet portal.
